(19) United States
(12) Patent Application Publication
(10) Pub. No.: US 2018/0248463 A1
(43) Pub. Date: Aug. 30, 2018

(54) Magnetic Gear Device

(71) Applicant: Hitachi Metals, Ltd., Tokyo (JP)

(72) Inventor: Akihiro Kimoto, Suita-shi, Osaka (JP)

(21) Appl. No.: 15/761,004

(22) PCT Filed: Sep. 21, 2016
(86) PCT No.: PCT/JP2016/077841

§ 371 Date: Mar. 16, 2018

(30) Foreign Application Priority Data
Sep. 24, 2015 (JP) 2015-187310

(51) Int. Cl. H02K 49/10

(52) U.S. Cl. CPC H02K 49/102

(57) ABSTRACT

A magnetic gear device comprises: a discoid first rotor on which a plurality of magnetic pole pairs are disposed along a circumferential direction; a first magnetic-field-modulating yoke on which a plurality of magnetic bodies are disposed along the circumferential direction and that modulates a spatial frequency of a magnetic field generated by the first rotor; a discoid second rotor a center line of which substantially coincides with a center line of the first rotor and on which a plurality of magnetic pole pairs are disposed along the circumferential direction; a second magnetic-field-modulating yoke on which a plurality of magnetic bodies are disposed along the circumferential direction and that modulates a spatial frequency of a magnetic field generated by the second rotor; and a discoid linking rotor that is disposed between the first magnetic-field-modulating yoke and the second magnetic-field-modulating yoke and magnetically links the first rotor and the second rotor via the first magnetic-field-modulating yoke and the second magnetic-field-modulating yoke.

### CROSS-REFERENCE TO RELATED APPLICATIONS

This application is the national phase under 35 U.S.C. § 371 of PCT International Application No. PCT/JP2016/077841 which has an International filing date of Sep. 21, 2016 and designated the United States of America.

### FIELD

The present invention relates to a magnetic gear device having an axial gap structure and transmitting power by using a magnetic force.

### BACKGROUND

Japanese Patent Application Laid-Open No. 2014-15992 discloses a magnetic gear device having a radial gap structure. The magnetic gear device according to Japanese Patent Application Laid-Open No. 2014-15992 is provided with: a first internal gear having a plurality of magnetic pieces on the outer periphery; a second internal gear disposed on the outer periphery side of the first internal gear and having a plurality of magnetic pieces on the inner periphery and on the outer periphery; and an external gear disposed on the outer periphery side of the second internal gear and having a plurality of magnetic pieces on the inner periphery. A magnetic teeth portion is disposed between the first internal gear and the second internal gear, and a magnetic teeth portion is also disposed between the second internal gear and the external gear. The magnetic gear device according to Patent Japanese Patent Application Laid-Open No. 2014-15992 structured as described above realizes a high gear ratio by radially disposing gears and magnetic teeth portions in multiple stages.

WO 2009/130456 discloses a magnetic gear device having an axial gap structure. The following are provided: a discoid first magnet array and second magnet array on each of which a plurality of magnetic pole pairs are disposed along the circumferential direction; and a discoid intermediate yoke disposed between the first and second magnet arrays and on which a plurality of magnetic bodies are disposed along the circumferential direction.

### SUMMARY

However, with the magnetic gear device according to Patent Document 1, there is a problem in that the size is increased in the radial direction. Moreover, with the magnetic gear device according to Patent Document 1, since it adopts a radial gap structure, there is a problem in that reduction in the size in the direction of the rotation axis is limited.

In the magnetic gear device according to Patent Document 2, since it adopts a general axial gap structure, size reduction and gear ratio improvement are limited.

It is an object to provide a small-size magnetic gear device having a high gear ratio.

A magnetic gear device according to the present disclosure comprises: a discoid first magnet array on which a plurality of magnetic pole pairs are disposed along a circumferential direction; a discoid first magnetic body array on which a plurality of magnetic bodies are disposed along the circumferential direction and that modulates a spatial frequency of a magnetic field generated by the first magnet array; a discoid second magnet array a center line of which substantially coincides with a center line of the first magnet array and on which a plurality of magnetic pole pairs are disposed along the circumferential direction; a discoid second magnetic body array on which a plurality of magnetic bodies are disposed along the circumferential direction and that modulates a spatial frequency of a magnetic field generated by the second magnet array; and a discoid linker that is disposed between the first magnetic body array and the second magnetic body array and magnetically links the first magnet array and the second magnet array via the first magnetic body array and the second magnetic body array.

In the present disclosure, since the magnet arrays and the magnetic body arrays, and the linker are discoid and arranged in the direction of the center line, size increase in the radial direction can be suppressed. Moreover, since the first magnet array and the first magnetic body array, and the second magnet array and the second magnetic body array are magnetically linked by the discoid linker, size increase in the direction of the center line can be suppressed compared with a structure in which a plurality of magnetic gears are simply arranged in the direction of the center line and linked by the rotation axis.

When the first magnet array and the first magnetic body array relatively rotate, the magnetic field of the first magnet array is modulated, and a rotating magnetic field having a frequency component of an order different from the number of magnet pairs of the first magnet array is generated. The rotation speed of the rotating magnetic field is different from the rotation speed of the first magnet array or the first magnetic body array, and the rotating magnetic field rotates at a gear ratio corresponding to the numbers of magnetic pole pairs and magnetic bodies. The rotating magnetic field generated by the second magnet array and the second magnetic body array has similar characteristics. The linker magnetically links the rotating magnetic field of the first magnet array and the rotating magnetic field of the second magnet array modulated as described above, and links the first magnet array and the second magnet array.

Therefore, when a rotation force is supplied to the first magnet array or the first magnetic body array, the rotation force is transmitted to the second magnet array or the second magnetic body array at a predetermined acceleration/deceleration ratio via the linker. The rotation speed is accelerated or decelerated in two steps on the side of the first magnet array and the first magnetic body array and on the side of the second magnet array and the second magnetic body array. The same applies to the opposite case: When a rotation force is supplied to the second magnet array and the second magnetic body array, the rotation force is transmitted to the first magnet array or the first magnetic body array at a predetermined acceleration/deceleration ratio via the linker.

In the present disclosure, when a rotation force is transmitted by using the magnetic gear device, either of the first magnet array and the first magnetic body array may be fixed. Likewise, either of the second magnet array and the second magnetic body array may be fixed.

In a magnetic gear device according to the present disclosure, the linker comprises: a discoid first linking magnet array a center line of which substantially coincides with the center line of the first magnet array and on which a plurality of magnetic pole pairs corresponding to the magnetic field modulated by the first magnetic body array are disposed in the circumferential direction; and a discoid second linking magnet array a center line of which substantially coincides with the center line of the second magnet array and on which a plurality of magnet pole pairs corresponding to the magnetic field modulated by the second magnetic body array are disposed in the circumferential direction, wherein the first linking magnet array and the second linking magnet array are relatively fixed in the circumferential direction.

In the present disclosure, since the first magnet array and the second magnet array are magnetically linked by the discoid linker having the first linking magnet array on the first magnet array side and having the second linking magnet array on the second magnet array side, size increase in the axial direction can be suppressed.

The present disclosure also includes a structure in which the discoid back yoke is interposed between the first linking magnet array and the second linking magnet array. When the back yoke is provided, since the coupling force between the first and second magnet arrays and the first and second linking rotors increases, the rotation force that can be transmitted increases, so that step-out can be prevented.

A magnetic gear device according to the present disclosure, comprises: a first tubular portion that supports and unitizes the first magnet array and the first magnetic body array; a second tubular portion that supports and unitizes the second magnet array and the second magnetic body array; and a third tubular portion that supports and unitizes the first linking magnet array and the second linking magnet array.

In the present disclosure, the magnetic gear device is constituted by three units. The first unit is the first magnet array and the first magnetic body array which are unitized, the second unit is the second magnet array and the second magnetic body array which are unitized, and the third unit is the first and second linking rotors which are unitized. According to the present disclosure, the gear ratio of the magnetic gear device can be easily changed by replacing the first or the third unit constituting the magnetic gear device with a different unit having different numbers of magnetic pole pairs and magnetic bodies. The third unit is replaced as required according to the change in gear ratio.

In a magnetic gear device according to the present disclosure, the first magnet array and the second magnet array are rotatably supported by the first tubular portion and the second tubular portion at bearings, respectively, and the first linking magnet array and the second linking magnet array are integrally rotatably supported by the third tubular portion at a bearing.

In the present disclosure, when a rotation force is supplied to the first magnet array, the rotation force is transmitted to the second magnet array via the linker, and the rotation speed thereof is accelerated or decelerated in two steps. Moreover, when a rotation force is supplied to the second magnet array, the rotation force is transmitted to the first magnet array via the linker, and the rotation speed thereof is accelerated or decelerated in two steps.

According to the present disclosure, a small-size magnetic gear device having a high gear ratio can be provided.

The above and further objects and features will more fully be apparent from the following detailed description with accompanying drawings.

### BRIEF DESCRIPTION OF THE DRAWINGS

FIG. 1 A side cross-sectional view showing a structure example of a magnetic gear device according to the present embodiment.

FIG. 2 A side cross-sectional view showing a structure example of a first rotor unit.

FIG. 3A A bottom view showing a structure example of a first rotor and a first magnetic-field-modulating yoke.

FIG. 3B A bottom view showing a structure example of the first rotor and the first magnetic-field-modulating yoke.

FIG. 4 A side cross-sectional view showing a structure example of a linking rotor unit.

FIG. 5A A top view and a bottom view showing a structure example of a linking rotor.

FIG. 5B A top view and a bottom view showing a structure example of the linking rotor.

FIG. 6 A side cross-sectional view showing a structure example of a second rotor unit.

FIG. 7A A top view showing a structure example of a second rotor and a second magnetic-field-modulating yoke.

FIG. 7B A top view showing a structure example of the second rotor and the second magnetic-field-modulating yoke.

FIG. 8 A conceptual diagram showing a combination of the numbers of magnet arrays and magnetic bodies constituting each unit.

FIG. 9 A conceptual view showing another example of the combination of the units.

### DETAILED DESCRIPTION

Hereinafter, the present disclosure will be described in detail based on the drawings showing an embodiment thereof.

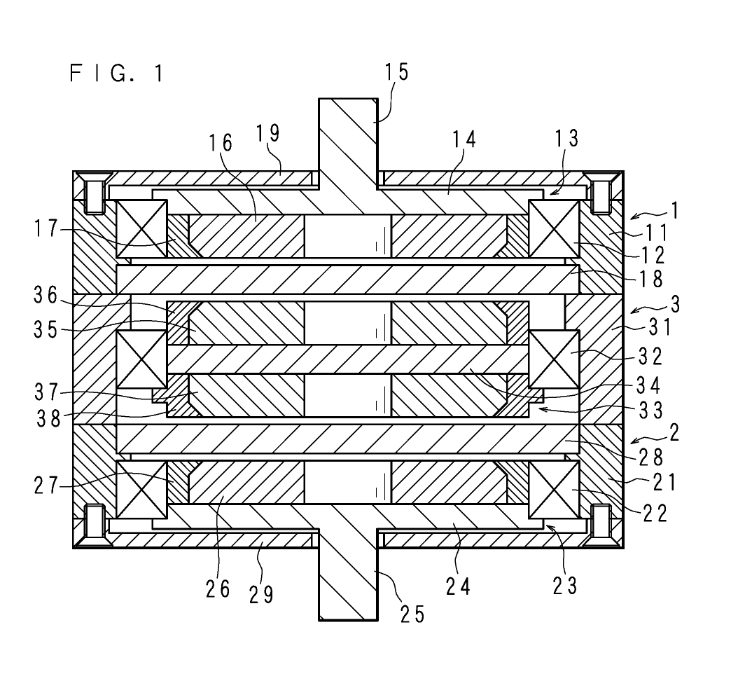

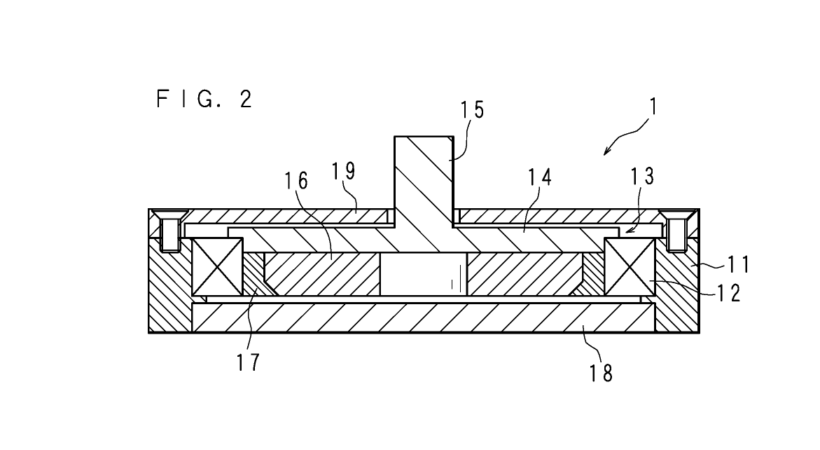

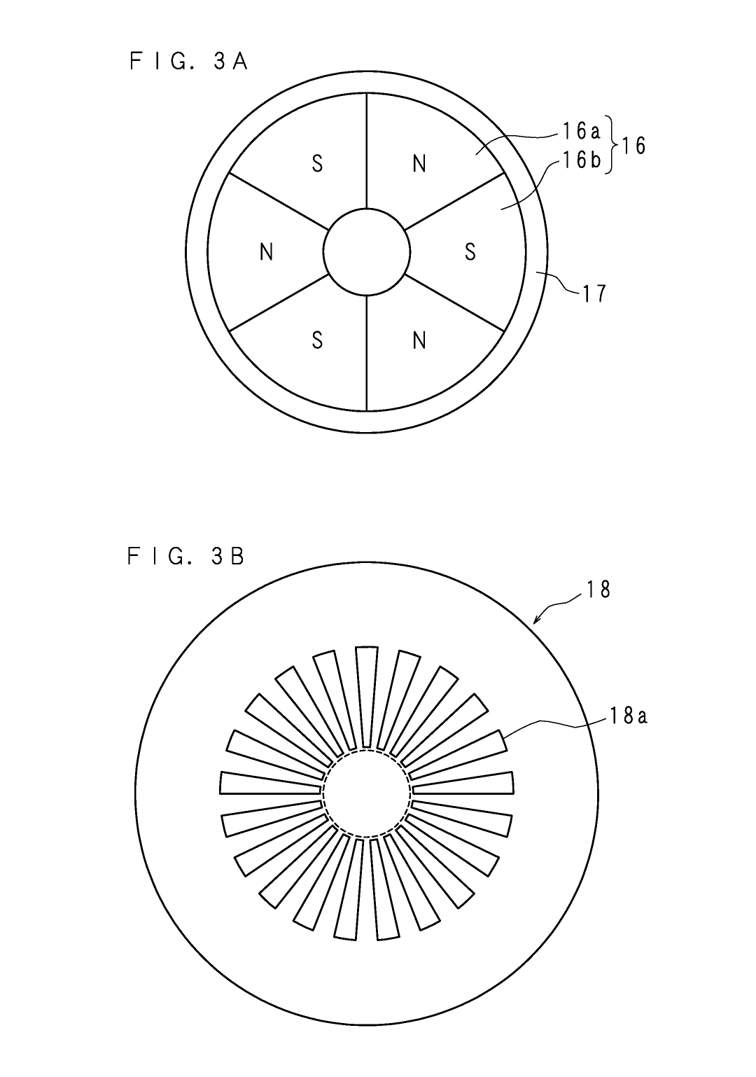

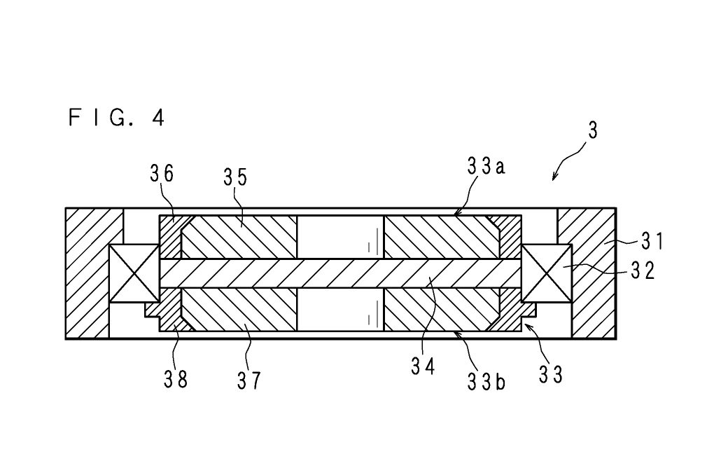

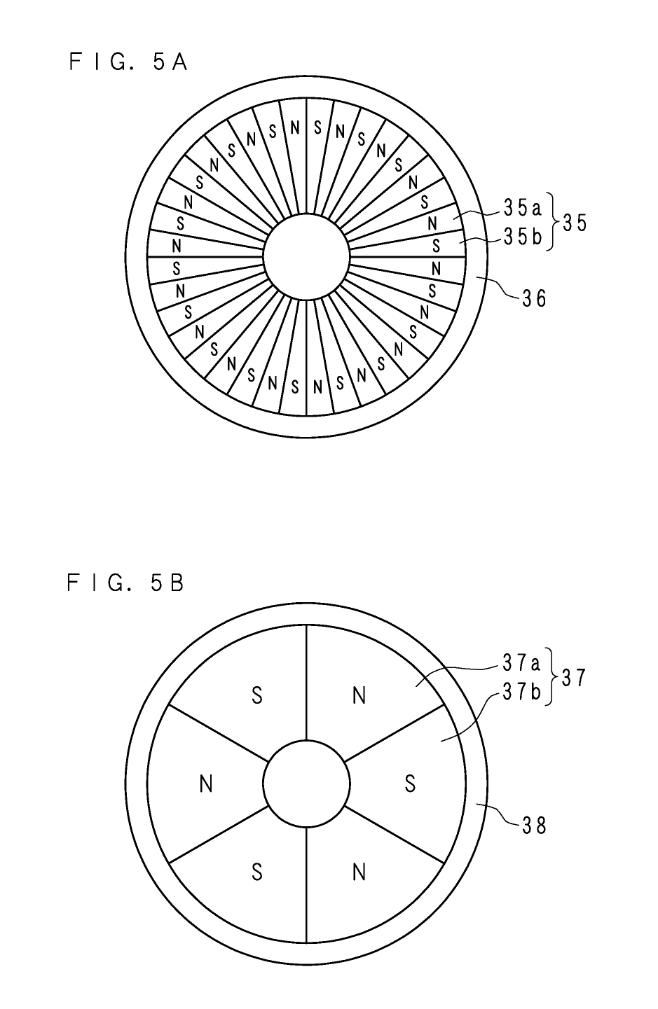

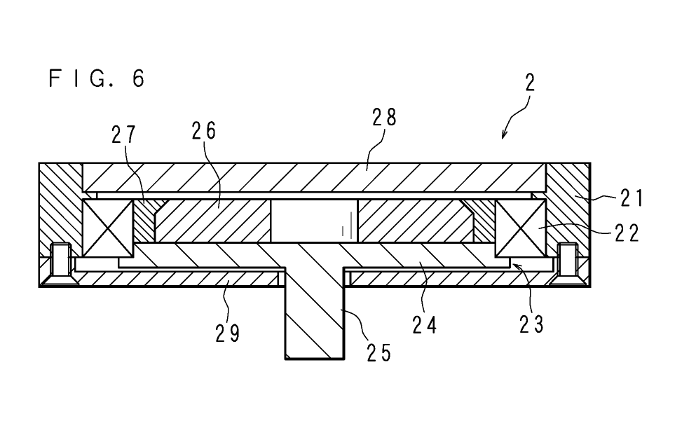

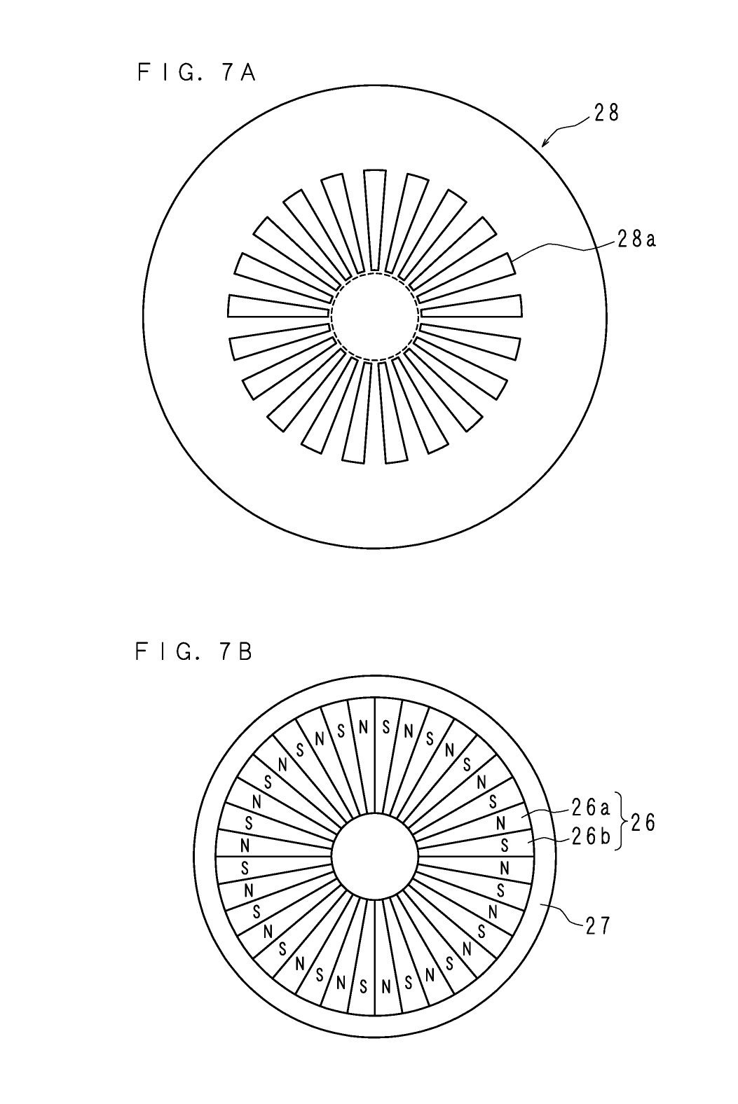

FIG. 1 is a side cross-sectional view showing a structure example of a magnetic gear device according to the present embodiment, FIG. 2 is a side cross-sectional view showing a structure example of a first rotor unit 1, FIG. 3A and FIG. 3B are bottom views showing structure examples of a first rotor 13 and a first magnetic-field-modulating yoke (first magnetic body array) 18, FIG. 4 is a side cross-sectional view showing a structure example of a linking rotor unit 3, FIG. 5A and FIG. 5B are a top view and a bottom view showing a structure example of a linking rotor 33, FIG. 6 is a side cross-sectional view showing a structure example of a second rotor unit 2, FIG. 7A and FIG. 7B are top views showing structure examples of a second rotor 23 and a second magnetic-field-modulating yoke (second magnetic body array) 28.

The magnetic gear device according to the embodiment of the present disclosure is cylindrical, and is provided with the discoid first rotor unit 1 and second rotor unit 2 disposed so that the rotation axes thereof coincide with each other and the linking rotor unit (linker) 3 that is disposed between the first and second rotor units 1 and 2 and magnetically links the units.

As shown in FIG. 1 and FIG. 2, the first rotor unit 1 is provided with a first tubular portion 11. The first tubular portion 11 is made of a non-magnetic material such as stainless steel. To the inner peripheral surface of the first tubular portion 11, the outer ring of a bearing 12 is press-fitted, and the first tubular portion 11 rotatably supports the discoid first rotor 13 (first magnet array) via the bearing 12 in such a manner that the rotation axis thereof substantially coincides with the center line of the first tubular portion 11. The thickness of the first rotor 13 is smaller than the length of the first tubular portion 11 in the direction of the center line, and the first rotor 13 is accommodated inside the first tubular portion 11.

In the present description, substantial coincidence means coincidence in design, and the expression, substantial coincidence, is used so that dimensional tolerance necessary for machining and the like and errors caused in the process of production are included. Moreover, coincidence in design does not necessarily mean complete coincidence but may include a case where the first rotor 13, the second rotor 23 and the linking rotor 33 rotate while being magnetically or mechanically linked together and the central axes disaccord within a range where the rotation force can be transmitted.

The first rotor 13 has a disc portion 14 made of a magnetic material, and on the center of one surface of the disc portion 14, an input and output shaft 15 protruding in the direction of the rotation axis is provided. On the other surface of the disc portion 14, three fan-shaped magnetic pole pairs 16 each formed of magnets 16a the outer surface side of which is the N pole and magnets 16b the outer surface side of which is the S pole which magnets are polarized in the direction of the thickness are disposed at substantially equal intervals along the circumferential direction as shown in FIG. 3A. The number of magnetic pole pairs 16 is an example and is set as appropriate according to a desired gear ratio. Here, the magnets 16a and 16b polarized in the direction of the thickness indicate that they are polarized so that the outer surface side (the lower side in FIG. 2) and the inner surface side (the upper side in FIG. 2) have different poles. For example, the outer surface side and the inner surface side of the magnets 16a are polarized to the N pole and to the S pole, respectively, and the outer surface side and the inner surface side of the magnet 16b are polarized to the S pole and to the N pole, respectively. The magnets 16a and 16b are rare earth-transition metal magnets (for example, Nd-Fe-B magnets), bond magnets, ferrite magnets or the like.

The outer peripheral portions of the outer surface side of the magnets 16a and 16b are chamfered, and a magnet array formed of the three chamfered magnetic pole pairs 16 disposed in the circumferential direction is molded in the shape of a disc as a whole by resin embedding. By resin-molding the magnetic pole pairs 16, a scattering prevention portion 17 that prevents the magnets 16a and 16b from being scattered by the centrifugal force due to the rotation of the first rotor 13 is formed on the outer peripheral portions of the magnets 16a and 16b. Specifically, as shown in FIG. 2 and FIG. 3A, the scattering prevention portion 17 which surrounds the outer periphery of the magnets 16a and 16b is an annular member that is hook-shaped in cross section and restricts the movement of the magnets 16a and 16b away from the disc portion 14.

In the present description, equal intervals mean equal intervals in design, and the expression, substantially equal intervals, is used so that dimensional tolerance necessary for machining and the like and errors caused in the process of production are included. Moreover, equal intervals in design do not necessarily mean complete coincidence but may include a case where the first rotor 13, the second rotor 23 and the linking rotor 33 rotate while being magnetically or mechanically linked together and the disposition intervals disaccord within a range where the rotation force can be transmitted.

Moreover, the first rotor unit 1 is provided with the discoid first magnetic-field-modulating yoke 18 that modulates the spatial frequency of the magnetic field generated by the first rotor 13. The first tubular portion 11 supports and fixes the first magnetic-field-modulating yoke 18 so that the first magnetic-field-modulating yoke 18 parallelly faces the surface of the first rotor 13 where the magnetic pole pairs 16 are disposed and covers one open end of the first tubular portion 11. The first magnetic-field-modulating yoke 18 is provided with twenty-one magnetic bodies 18a disposed at substantially equal intervals along the circumferential direction as shown in FIG. 3B and a discoid holding member that holds the magnetic bodies 18a. The first magnetic-field-modulating yoke 18 is produced, for example, by fixing the magnetic bodies 18a to a resin formed in a disc shape (for example, see WO 2009/087408). An alternating magnetic field containing a third harmonic component, a seventh harmonic component and a thirteenth harmonic component caused by the magnetic bodies 18a intersects with the first magnetic-field-modulating yoke 18 in the axial direction. The number of magnetic bodies 18a is an example and is set as appropriate according to a desired gear ratio. As the magnetic bodies 18a, for example, soft magnetic bodies made of a magnetic metal, a laminated steel plate formed of a plurality of laminated magnetic plates, a green compact of magnetic powder or the like are used. In particular, as the material of the magnetic bodies 18a, a laminated steel plate is preferable since it can suppress the eddy-current loss.

Further, the first rotor unit 1 is provided with a lid portion 19 that covers the other open end of the first tubular portion 11. A hole portion is formed in the center of the lid portion 19, and the input and output shaft 15 of the first rotor 13 rotatably protrudes from the hole portion.

The second rotor unit 2 has a similar structure to the first rotor unit 1 as shown in FIG. 6, and is provided with a second tubular portion 21 made of a non-magnetic material such as stainless steel and the discoid second rotor 23 (second magnet array). To the inner peripheral surface of the second tubular portion 21, the outer ring of a bearing 22 is press-fitted, and the second tubular portion 21 rotatably supports the second rotor 23 via the bearing 22 in such a manner that the rotation axis thereof substantially coincides with the center line of the second tubular portion 21. The thickness of the second rotor 23 is smaller than the length of the second tubular portion 21 in the direction of the center line, and the second rotor 23 is accommodated inside the second tubular portion 21.

The second rotor 23 has a disc portion 24 made of a magnetic material, and on the center of one surface of the disc portion 24, an input and output shaft 25 protruding in the direction of the rotation axis is provided. On the other surface of the disc portion 24, eighteen fan-shaped magnetic pole pairs 26 each formed of magnets 26a the outer surface side of which is the N pole and magnets 26b the outer surface side of which is the S pole which magnets are polarized in the direction of the thickness are disposed at substantially equal intervals along the circumferential direction as shown in FIG. 7B. The number of magnetic pole pairs 26 is an example and is set as appropriate according to a desired gear ratio. The outer peripheral portions of the outer surface side of the magnets 26a and 26b are chamfered, and a magnet array formed of the eighteen chamfered magnetic pole pairs 26 disposed in the circumferential direction is molded in the shape of a disc as a whole by resin embedding.

By resin-molding the magnetic pole pairs 26, a scattering prevention portion 27 that prevents the magnets 26a and 26b from being scattered by the centrifugal force due to the rotation of the second rotor 23 is formed on the outer peripheral portions of the magnets 26a and 26b. As shown in FIG. 6 and FIG. 7B, the scattering prevention portion 27 which surrounds the outer periphery of the magnets 26a and 26b is an annular member that is hook-shaped in cross section and restricts the movement of the magnets 26a and 26b away from the disc portion 24.

Moreover, the second rotor unit 2 is provided with the discoid second magnetic-field-modulating yoke 28 that modulates the spatial frequency of the magnetic field generated by the second rotor 23. The second tubular portion 21 supports and fixes the second magnetic-field-modulating yoke 28 so that the second magnetic-field-modulating yoke 28 parallelly faces the surface of the second rotor 23 where the magnetic pole pairs 26 are disposed and covers one open end of the second tubular portion 21. The second magnetic-field-modulating yoke 28 is provided with twenty-one magnetic bodies 28a disposed at substantially equal intervals along the circumferential direction as shown in FIG. 7A and a discoid holding member that holds the magnetic bodies 28a. The number of magnetic bodies 28a is an example and is set as appropriate according to a desired gear ratio.

Further, the second rotor unit 2 is provided with a lid portion 29 that covers the other open end of the second tubular portion 21. A hole portion is formed in the center of the lid portion 29, and the input and output shaft 25 of the second rotor 23 rotatably protrudes from the hole portion.

The linking rotor unit 3 is provided with a third tubular portion 31 the outer diameter of which is substantially the same as those of the first and second tubular portions 11 and 21. The third tubular portion 31 is disposed between the first rotor unit 1 and the second rotor unit 2 so that the center line substantially coincides, and links the first and second rotor units 1 and 2. The thickness of the linking rotor 33 is smaller than the length of the third tubular portion 31 in the direction of the center line, and the linking rotor 33 is accommodated inside the third tubular portion 31. The third tubular portion 31 is made of a non-magnetic material such as stainless steel. To the inner peripheral surface of the third tubular portion 31, the outer ring of a bearing 32 is press-fitted, and the third tubular portion 31 rotatably supports the linking rotor 33 via the bearing 32 in such a manner that the rotation axis thereof substantially coincides with the center line of the third tubular portion 31.

The linking rotor 33 has a discoid back yoke 34 made of a magnetic material. On the first rotor unit 1 side disc surface of the back yoke 34, as shown in FIG. 5A, eighteen fan-shaped magnetic pole pairs 35 each formed of magnets 35a the outer surface side (the upper side in FIG. 4) of which is the N pole and magnets 35b the outer surface side of which is the S pole which magnets are polarized in the direction of the thickness are disposed at substantially equal intervals along the circumferential direction. The outer peripheral portions of the outer surface side of the magnets 35a and 35b are chamfered, and a magnet array formed of the eighteen chamfered magnetic pole pairs 35 disposed in the circumferential direction is molded in the shape of a disc as a whole by resin embedding, thereby constituting a first linking magnet array 33a. The magnetic pole pairs 35 and the disc surface of the first magnetic-field-modulating yoke 18 face each other with a gap therebetween, and the magnetic pole pairs 35 are magnetically coupled to the first rotor 13 via the first magnetic-field-modulating yoke 18. Moreover, the linking rotor 33 is provided with a scattering prevention portion 36 that prevents the magnets 35a and 35b from being scattered by the centrifugal force due to the rotation of the linking rotor 33. The structure of the scattering prevention portion 36 is similar to that of the scattering prevention portion 17.

The number of magnetic pole pairs 35 is an example and is set as appropriate according to a desired gear ratio. However, it is preferable that the numbers of magnetic pole pairs 16 and magnetic bodies 18a of the first rotor unit 1 and the number of magnetic pole pairs 35 of the linking rotor unit 3 satisfy the following expression (1) (Tetsuya IKEDA, Kenji NAKAMURA, and Osamu ICHINOKURA, “A Way to Improve Efficiency of Permanent-Magnet Magnetic Gears”, Journal of the Magnetics Society of Japan, 2009, vol. 33, no. 2, pp. 130-134):

p2=ns1±p1 (1)

Here,

p1 is the number of magnetic pole pairs 16,
p2 is the number of magnetic pole pairs 35, and
ns1 is the number of magnetic bodies 18a.

The present embodiment where p1=3, p2=18 and ns1=21 satisfies the above expression (1).

On the second rotor unit 2 side disc surface of the back yoke 34, as shown in FIG. 5B, three fan-shaped magnetic pole pairs 37 each formed of magnets 37a the outer surface side (the lower side in FIG. 4) of which is the N pole and magnets 37b the outer surface side of which is the S pole which magnets are polarized in the direction of the thickness are disposed at substantially equal intervals along the circumferential direction. The outer peripheral portions of the outer surface side of the magnets 37a and 37b are chamfered, and a magnet array formed of the three chamfered magnetic pole pairs 37 disposed in the circumferential direction is molded in the shape of a disc as a whole by resin embedding, thereby constituting a second linking magnet array 33b. The magnetic pole pairs 37 and the disc surface of the second magnetic-field-modulating yoke 28 face each other with a gap therebetween, and the magnetic pole pairs 37 are magnetically coupled to the second rotor 23 via the second magnetic-field-modulating yoke 28. Moreover, the linking rotor 33 is provided with a scattering prevention portion 38 that prevents the magnets 37a and 37b from being scattered by the centrifugal force due to the rotation of the linking rotor 33. The structure of the scattering prevention portion 38 is similar to that of the scattering prevention portion 17.

The number of magnetic pole pairs 37 is an example and is set as appropriate according to a desired gear ratio. However, like the first rotor unit 1 side, it is preferable that the numbers of magnetic pole pairs 26 and magnetic bodies 28a of the second rotor unit 2 and the number of magnetic pole pairs 37 of the linking rotor unit 3 satisfy the following expression (2):

p4=ns2±p3 (2)

Here,

p3 is the number of magnetic pole pairs 37,
p4 is the number of magnetic pole pairs 26, and
ns2 is the number of magnetic bodies 28a.

The present embodiment where p3=3, p4=18 and ns2=21 satisfies the above expression (2).

Next, the operation and effects of the magnetic gear device according to the present embodiment will be described.

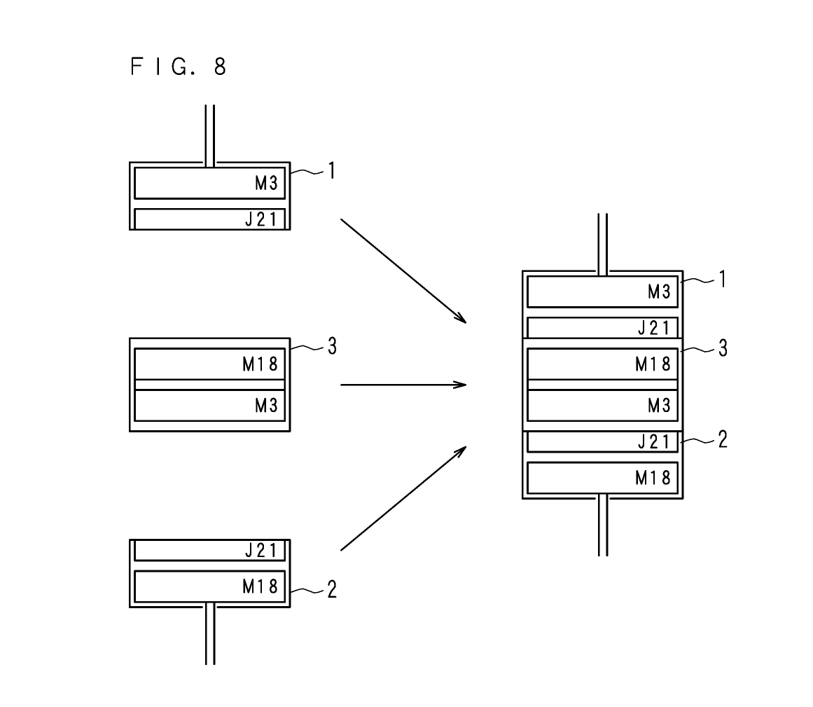

FIG. 8 is a conceptual diagram showing a combination of the numbers of magnet arrays and magnetic bodies constituting each unit. As shown in FIG. 8, the magnetic gear device is constituted by three units, that is, the first rotor unit 1, the second rotor unit 2 and the linking rotor unit 3. The magnetic gear device of the present embodiment can be manufactured by linking the first and second rotor units 1 and 2 with the linking rotor unit 3 therebetween. While the method of linking the units is not specifically limited, the units may be linked by screws or may be linked by welding. In FIG. 8, “M3” and “M18” represent three magnetic pole pairs and eighteen magnetic pole pairs, respectively, and “J21” represents twenty-one magnetic bodies.

When the first rotor 13 rotates, the linking rotor 33 is rotated by the magnetic interaction between the magnetic pole pairs 16 and 35 possessed by the first rotor 13 and the linking rotor 33. When the first rotor unit 1 and the linking rotor unit 3 satisfy the following expression (3), the gear ratio between the rotation speeds of the first rotor 13 and the linking rotor 33 is expressed by the following expression (4):

p2=ns1−p1 (3)

ω1/ω0=−p1/(ns1−p1) (4)

Here,

ω0 is the rotation speed of the first rotor 13, and
ω1 is the rotation speed of the linking rotor 33.

When p1=3, p2=18 and ns1=21, ω1/ω0=−⅙, and the first rotor 13 and the linking rotor 33 rotate in opposite directions at a gear ratio of ⅙.

Likewise, when the linking rotor 33 rotates, the second rotor 23 is rotated by the magnetic interaction between the magnetic pole pairs 37 and 26 possessed by the linking rotor 33 and the second rotor 23. When the second rotor unit 2 and the linking rotor unit 3 satisfy the following expression (5), the gear ratio between the linking rotor 33 and the second rotor 23 is expressed by the following expression (6):

p4=ns2−p3 (5)

ω2/ω1=−p3/(ns2−p3) (6)

Here,

ω2 is the rotation speed of the second rotor 23.

When p3=3, p4=18 and ns2=21, ω2/ω1=−⅙, and the linking rotor 33 and the second rotor 23 rotate in opposite directions at a gear ratio of ⅙.

Therefore, the gear ratio between the first rotor 13 and the second rotor 23 is expressed by the following expression (7), and when the numbers of magnetic pole pairs 16 and magnetic bodies 18a are set as shown in FIG. 8, ω2/ω0= 1/36.

ω2/ω0=p1/(ns1−p1)×p3/(ns2−p3) (7)

In the magnetic gear device structured as described above, the rotation force inputted to the input and output shaft 15 or the input and output shaft 25 is accelerated or decelerated in two steps. That is, where only a gear ratio of ⅙ can be obtained only with a single first rotor unit 1 or second rotor unit 2, a gear ratio of ⅙×⅙= 1/36 can be obtained by linking the first and second rotor units 1 and 2 by the linking rotor unit 3.

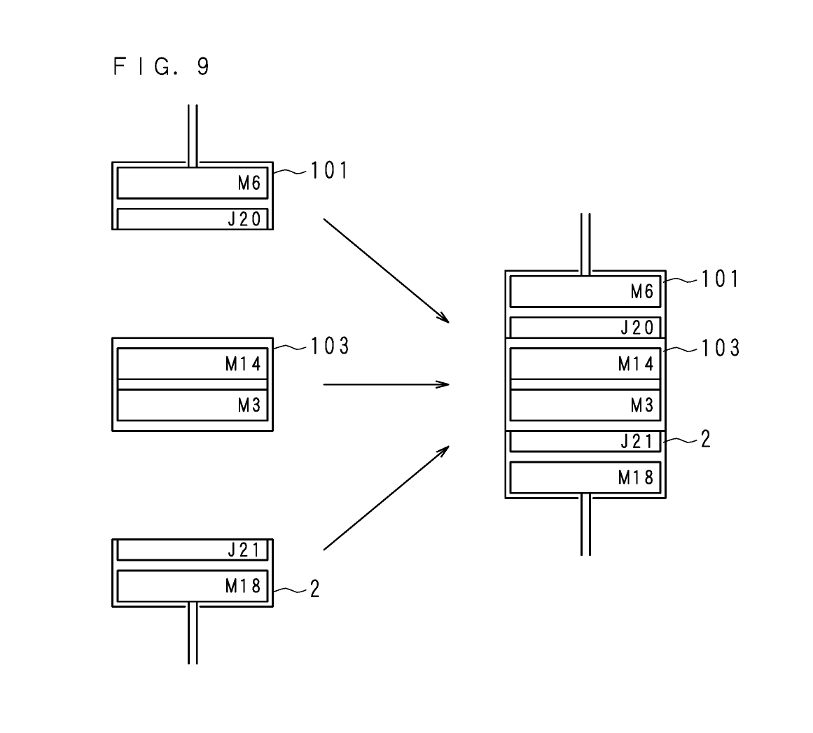

FIG. 9 is a conceptual view showing another example of the combination of the units. While the magnetic gear device is constituted by three units like the magnetic gear device shown in FIG. 8, a magnetic gear device having a desired gear ratio can be easily structured by replacing some of the units with a different unit having different numbers of magnetic pairs and magnetic bodies. For example, in the example of FIG. 9, the first rotor unit 1 is replaced with a first rotor unit 101 where the number of magnetic pole pairs is six and the number of magnetic bodies is twenty, and the linking rotor unit 3 is replaced with a linking rotor unit 103 where the number of magnetic pole pairs is fourteen on the first rotor unit side and is three on the second rotor unit side.

In the case of the example shown in FIG. 9, a magnetic gear device having a gear ratio of (− 6/14)×(−⅙)= 1/14 can be obtained.

Moreover, according to the numbers of magnetic pole pairs and magnetic bodies of the replacing unit, the rotation direction can be reversed. The rotation directions of the input and output shaft 15 and the input and output shaft 25 can also be reversed.

Specifically, when the first rotor 13 and the linking rotor 33 satisfy the following expression (8), the ratio between the rotation speeds thereof is expressed by the following expression (9). In this case, the rotations of the first rotor 13 and the linking rotor 33 are in the same direction.

p2=ns1+p1 (8)

ω1/ω0=p1/(ns1+p1) (9)

Likewise, when the second rotor 23 and the linking rotor 33 satisfy the following expression (10), the ratio between the rotation speeds thereof is expressed by the following expression (11). In this case, the rotations of the second rotor 23 and the linking rotor 33 are in the same direction.

p4=ns2+p3 (8)

ω2/ω1=p3/(ns2+p3) (11)

As described above, according to the magnetic gear device according to the present embodiment, by adopting the axial gap structure and magnetically linking the first and second rotor units 1 and 2 by the discoid linking rotor unit 3, a high gear ratio can be realized with a small-size magnetic gear device.

Moreover, since the first rotor unit 1 and the second rotor unit 2 are magnetically linked by the flat discoid linking rotor 33 where the magnetic pole pairs 35 and the magnetic pole pairs 37 are disposed in the circumferential direction on the disc surfaces of the back yoke 34, size increase in the rotation axis direction of the magnetic gear device due to the linking can be minimized, so that size reduction of the magnetic gear device can be realized.

Further, by replacing some of the three units constituting the magnetic gear device, a magnetic gear device having a desired gear ratio can be easily manufactured.

Furthermore, by replacing some of the three units constituting the magnetic gear device, the rotation directions of the input and output shafts 15 and 25 can be changed to the same direction or to the opposite directions.

Further, by providing the scattering prevention portions 17, 27, 36 and 38, the first rotor 13 having the magnetic pole pairs 16, the second rotor 23 having the magnetic pole pairs 26 and the linking rotor 33 having the magnetic pole pairs 35 and 37 are made rotatable and the first magnetic-field-modulating yoke 18 and the second magnetic-field-modulating yoke 28 are fixed. Thereby, the structure of the magnetic gear device is simplified and the number of parts is reduced, which enables cost reduction.

While in the present embodiment, the structure is described in which the first and second magnetic-field-modulating yokes 18 and 28 are fixed and the first and second rotors 13 and 23 are rotated, a structure may be adopted in which the first and second rotors 13 and 23 are fixed and the first and second magnetic-field-modulating yokes 18 and 28 are rotated. In this case, the first and second magnetic-field-modulating yokes 18 and 28 are provided with an input and output shaft, an input and output ring or the like to and from which the rotation force is inputted and outputted.

It is to be noted that, as used herein and in the appended claims, the singular forms “a”, “an”, and “the” include plural referents unless the context clearly dictates otherwise.

The embodiments disclosed above are to be regarded as exemplary at all points and as not restrictive. The scope of the present invention is defined by the scope of the claims rather than the above-described meaning and is intended to include all changes within the scope of the claims and the scope or the meaning equivalent thereto.

What is claimed is:

1. A magnetic gear device comprising:
a discoid first magnet array on which a plurality of magnetic pole pairs are disposed along a circumferential direction;
a discoid first magnetic body array on which a plurality of magnetic bodies are disposed along the circumferential direction and that modulates a spatial frequency of a magnetic field generated by the first magnet array;
a discoid second magnet array a center line of which substantially coincides with a center line of the first magnet array and on which a plurality of magnetic pole pairs are disposed along the circumferential direction;
a discoid second magnetic body array on which a plurality of magnetic bodies are disposed along the circumferential direction and that modulates a spatial frequency of a magnetic field generated by the second magnet array; and
a discoid linker that is disposed between the first magnetic body array and the second magnetic body array and magnetically links the first magnet array and the second magnet array via the first magnetic body array and the second magnetic body array.

2. The magnetic gear device according to claim 1,
wherein the linker comprises:
a discoid first linking magnet array a center line of which substantially coincides with the center line of the first magnet array and on which a plurality of magnetic pole pairs corresponding to the magnetic field modulated by the first magnetic body array are disposed in the circumferential direction; and
a discoid second linking magnet array a center line of which substantially coincides with the center line of the second magnet array and on which a plurality of magnet pole pairs corresponding to the magnetic field modulated by the second magnetic body array are disposed in the circumferential direction,
wherein the first linking magnet array and the second linking magnet array are relatively fixed in the circumferential direction.

3. The magnetic gear device according to claim 2, comprising:
a first tubular portion that supports and unitizes the first magnet array and the first magnetic body array;
a second tubular portion that supports and unitizes the second magnet array and the second magnetic body array; and
a third tubular portion that supports and unitizes the first linking magnet array and the second linking magnet array.

4. The magnetic gear device according to claim 3,
wherein the first magnet array and the second magnet array are rotatably supported by the first tubular portion and the second tubular portion at bearings, respectively, and the first linking magnet array and the second linking magnet array are integrally rotatably supported by the third tubular portion at a bearing.
